(19) United States
(12) Patent Application Publication
(10) Pub. No.: US 2015/0356585 A1
(43) Pub. Date: Dec. 10, 2015

(54) WEB-BASED ONLINE GAME FOR MERCHANTS AND BUYERS

(71) Applicant: Talla Thiam, Oklahoma City, OK (US)

(72) Inventor: Talla Thiam, Oklahoma City, OK (US)

(21) Appl. No.: 14/731,399

(22) Filed: Jun. 4, 2015

Related U.S. Application Data
(60) Provisional application No. 62/008,520, filed on Jun. 6, 2014.

(51) Int. Cl. G06Q 30/02

(52) U.S. Cl. CPC G06Q 30/0209

(57) ABSTRACT

A website and/or an App allows merchants and individual sellers list their products and services. On the same website, buyers will play a game. Merchants or sellers will have two options. One option: let the buyers play a game, a portion of a game, a level of a game, which can be a trivia game, or an electronic game. If the buyer or buyers win(s), then the price of the product or service will drop by a certain amount in price; but if the buyer or buyers lose, then price of the product will go up a certain amount in price. Another option: the merchants or individual sellers will list X number of the products, and let the buyer play within a time frame. The buyers having the best score or best time frame will have the best discounted price.

### CROSS REFERENCE TO RELATED APPLICATIONS

This application claims the priority of Provisional Application No. 62/008,520 filed on Jun. 6, 2014, inventor Talla Thiam, entitled “Web-Based Online Game for Merchants and Buyers”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to an online game, and more particularly to a web-based game for merchants and buyers.

### BACKGROUND OF THE INVENTION

It is a problem in the art to gain the interest of buyers, and to increase sales by providing discounts.

It is desirable to limit the amount/number of discounts available, but in usual forms of advertising and in usual sales conducted by businesses, the discount is the same for all buyers. If the discount could be limited or scaled, it would be possible to offer greater discounts to a few buyers.

### SUMMARY OF THE INVENTION

From the foregoing, it is seen that it is a problem in the art to provide a system meeting the above requirements. According to the present invention, a system is provided which meets the aforementioned requirements and needs in the prior art.

The present invention is directed to a website and/or an App where merchants and individual sellers will list their products (used and/or new) and services. On the same website—or on different website or on an electronic device or an App, or a combination of all or any two or three of these four platforms—buyers will play a game. And the merchants or individual sellers will have two options, as follows.

One option: let the buyers play a game, a portion of a game, a level of a game, or a combination of these three or any combination of two of the three. The game can be a trivia game, an electronic game, or any other any kind of game playable in this type of medium. If the buyer or buyers win(s), then the price of the product or service will drop by a certain amount in price; but if the buyer or buyers lose, then price of the product will go up a certain amount in price. And the buyer or buyers can play the game—or portion of a game, level of a game or combination of all the three or any combination of two of the three) once or more than once. After the buyer or buyers stop playing a game after one or a few plays, whatever amount the price ends up being, that's what they will be paying for that product.

Another option: the merchants or individual sellers will list X number (i.e., a selected number) of one of the same products (used or new) or different products, and let the buyer or buyers play a game, a portion of a game, a level of a game, or a combination of the three or any combination of two of the three, within a time frame. Whoever (from the buyers) has the best score or the best score and the best time will have the best discounted price. Merchants or individual sellers will give a bigger discount to the buyer with the best score, while the buyer with the second best score will have the second biggest discount of that group of products, and so on. This continues on in similar fashion until the buyer with a lowest score (with or without the best time), who will buy the products at the smallest discount. Also, the Merchants can give the biggest discount of that group of products or services, for example, to the 30 buyers with the 30 best scores (with or without the best times), the second best discount to the 10 or 20 or 30 or 40 (i.e. any chosen number) buyers with the 10 or 20 or 30 or 40 best scores, and so on. The smallest discount goes to the last buyers with the lowest scores (with or without the best times).

An important feature is that the merchants or sellers need not offer discounted prices for all the participants of the game. For example, let's say a merchant lists to sell 120 tablet computers at a regular price of $500 for three days (time frame), and 400 potential buyers played the game during that time frame, the merchant may offer the very best discounted prices of $420 to each of 30 potential buyers with the best scores (with or without the best times), the 50 potential buyers or gamers with the next best scores with the second best discounted prices of $440, and the 40 potential buyers with the next best scores with the third best discounted prices of $455. In that case, the rest of the pool of 400 players who are outside the best 120 scores get no discount and are therefore out of luck.

Other objects and advantages of the present invention will be more readily apparent from the following detailed description when read in conjunction with the accompanying drawings.

### BRIEF DESCRIPTION OF THE DRAWINGS

FIG. 1 is a flowchart which schematically depicts steps used in the system according to the present invention, wherein a seller(s) lists a product or group of products.

FIG. 2 is a flowchart which schematically depicts steps used in the system according to the present invention, wherein a buyer(s) plays a game.

FIG. 3 is a flowchart which schematically depicts steps used in the system according to the present invention, wherein a group of buyers plays a game, and different discounts are provided for groups of buyers in specific ranges of scores.

FIG. 4 is a schematic diagram of a computer connected to a network, for operating the system according to the present invention.

### DETAILED DESCRIPTION OF THE INVENTION

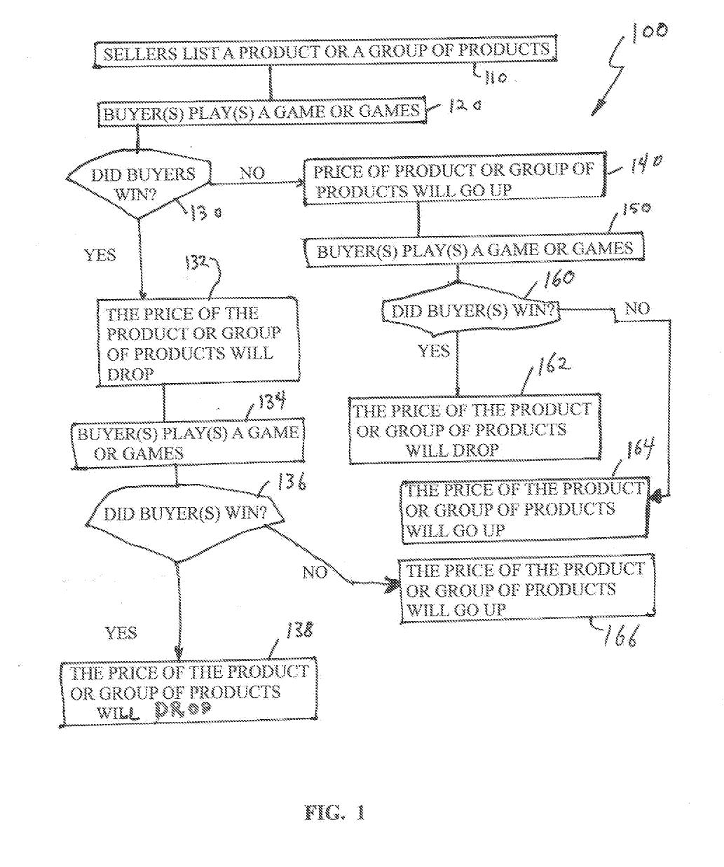

The device of the present invention relates to an online game, and more particularly to a web-based game for merchants and buyers. FIGS. 1, 2, and 3 are described below.

FIG. 1 is a flowchart which schematically depicts steps (discussed hereunder) used in a first system 100 of the present invention, wherein a seller(s) lists a product or group of products.

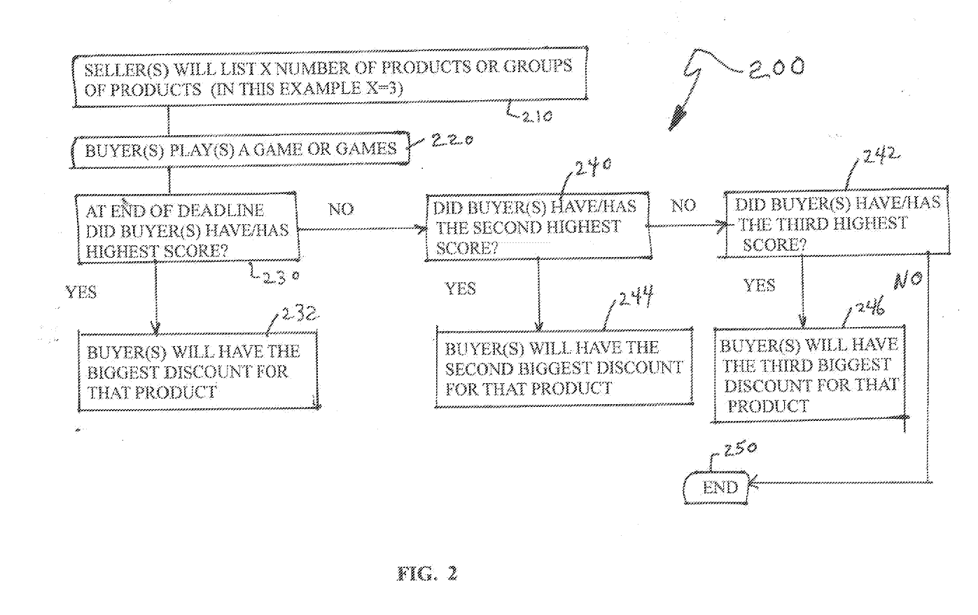

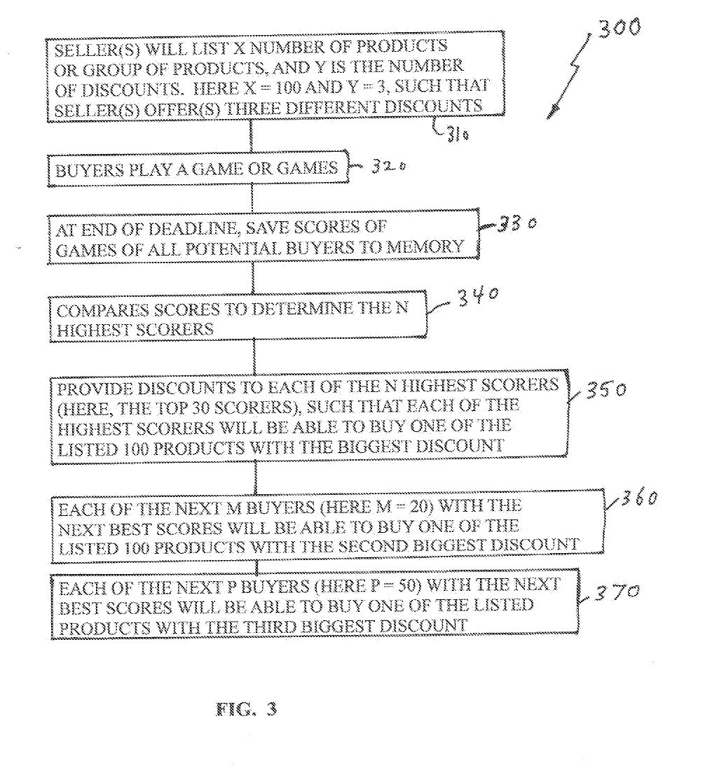

In this figure, and in the following FIGS. 2 and 3, where the word “buyer” is used, it includes either or both of an actual buyer and a potential buyer. Also, where the word “buyer” is used, it can include one buyer or a group of buyers.

FIG. 2 is a flowchart which schematically depicts steps (discussed hereunder) used in a second system 200 according to the present invention, wherein a buyer(s) plays a game.

FIG. 3 is a flowchart which schematically depicts steps (discussed hereunder) used in a third system 300 according to the present invention, wherein a group of buyers plays a game, and different discounts are provided for groups of buyers in specific ranges of scores.

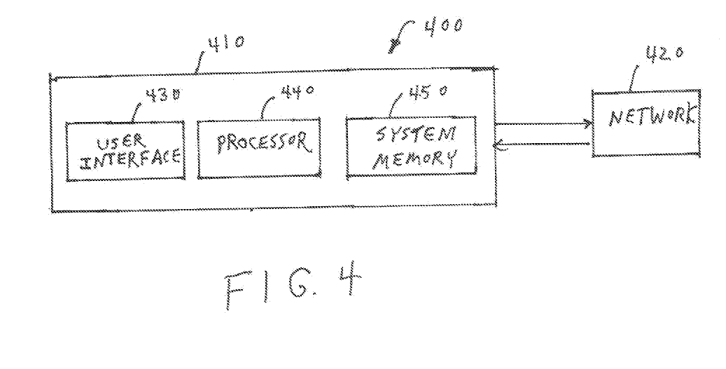

FIG. 4 is a schematic diagram of a computer 400 connected to a network 420, for operating the systems 100, 200 and 300 according to the present invention. The network can be a cell phone network, and publicly available network connection, and/or any other type of network connection. The computer 400 includes a user interface 430, a processor 440, and a system memory 450. The computer 400 can include other elements and features, and/or other types of system including mobile platforms such as cell phones, tablet computers, and so on. All such variations, which would be known to any one having skill in the computing arts, are contemplated as being within the scope of the present invention.

Referring to FIGS. 1, 2, and 3, the present invention is directed to the above-noted first, second, and third systems 100, 200, and 300 which are provided to support a website where merchants and individual sellers can list their products (used and/or new) and can list their services. On the same website—or on different website or on an electronic device or an App, or a combination of all or any two or three of these four platforms—buyers can play a game which has an outcome that can affect prices of the products being offered for sale by the aforementioned seller(s). And, the merchants or individual sellers will have two options, as follows.

One option: let the buyers play a game, a portion of a game, a level of a game, or a combination of these three or any combination of two of the three. The game can be a trivia game, an electronic game, or any other any kind of game playable in this type of medium. If the buyer or buyers win(s), then the price of the product or service will drop by a certain amount in price; but if the buyer or buyers lose, then price of the product will go up a certain amount in price. And the buyer or buyers can play the game - or portion of a game, level of a game or combination of all the three or any combination of two of the three) once or more than once. After the buyer or buyers stop playing a game after one or a few plays, whatever amount the price ends up being, that's what they will be paying for that product.

Another option: the merchants or individual sellers will list X number (i.e., a selected number) of one of the same products (used or new) or different products, and let the buyer or buyers play a game, a portion of a game, a level of a game, or a combination of the three or any combination of two of the three, within a time frame. Whoever (from the buyers) has the best score or the best score and the best time will have the best discounted price. Merchants or individual sellers can give a number Y of different levels of discount. That is, the merchants or individual sellers will give the biggest discount on that group of products to the buyer with the best score; merchants or individual sellers will give a second biggest discount (i.e. second level of discount) to the buyer with the second best score on that group of products; a third biggest discount for the third best score; and so on for the Y number of levels of discount. This continues on in similar fashion until the buyer with a lowest score (with or without the best time), who will buy the products at the smallest discount. Also, the merchants can give the biggest discount of that group of products or services, for example, to the 30 buyers with the 30 best scores (with or without the best times), the second best discount to the 10 or 20 or 30 or 40 (i.e. any chosen number) buyers with the 10 or 20 or 30 or 40 best scores, and so on. The smallest discount goes to the last buyers with the lowest scores (with or without the best times).

An important feature is that the merchants or sellers need not offer discounted prices for all the participants of the game. For example, let's say a merchant lists to sell 120 name brand tablet computers at a regular price of $500 for three days (time frame), and 400 potential buyers played the game during that time frame, the merchant may offer the very best discounted prices of $420 to each of 30 potential buyers with the best scores (with or without the best times), the 50 potential buyers or gamers with the next best scores with the second best discounted prices of $440, and the 40 potential buyers with the next best scores with the third best discounted prices of $455. In that case, the rest of the pool of 400 players who are outside the best 120 scores get no discount.

In FIG. 1, the steps of the first system 100 are as follows. At step 110, sellers list a product or group of products. At step 120, the buyer(s) play(s) a game or games. At step 130, a determination is made as to whether the buyers win (e.g., “did the buyers win”), and if YES branches to step 132 where the price of the product or group of products will drop; and if NO the first system 100 branches to step 140 in which the price of the product or group of products will go up.

Following step 132, the buyer(s) play(s) a game or games (e.g., another game or games), which leads to a decision step 136 to determine whether the buyer(s) win or not, i.e. “Did the buyer(s) win”. If the answer is YES the system 100 branches to step 138, wherein the price of the product or group of products will drop. If the answer is NO, then the system 100 branches to step 166 wherein the price of the product or group of products will go up.

Following step 140, the system 100 follows step 150, wherein the buyer(s) play(s) a game or games. At step 160 a determination is made as to whether or not the buyer(s) have won, i.e. “did buyers win?”, and if NO branches to step 164 wherein the price of the product or group of products will go up; while if YES branches to step 162 wherein the price of the product or group of products will drop.

The amount of the price drop or price increase for each step is selectable by the seller(s). Further, the buyer(s) or potential buyer(s) can play a game or games more than one time as long as the seller agrees (e.g. criteria can be preprogrammed in software or in memory, or the seller can be allowed to select the number in advance or change the criteria. In the first system 100, wherever the term “buyer” is shown, that term is understood to include buyers and potential buyers.

In FIG. 2 the second system 200 includes the flowchart as shown, wherein at step 210 the seller(s) will list X number of products or groups of products. In the example, X=3. At step 220 the buyer(s) play(s) a game or games. A deadline exists, and at step 230 a determination is made as to whether the buyer(s) have/has the highest score; if NO then the second system 200 branches to step 240, while if the answer is YES then the second system 200 branches to step 232 wherein the buyer(s) will have the biggest discount for that product.

At step 240, a determination is made whether the buyer(s) have/has the second highest score, and if NO branches to step 242, while if the answer is YES branches to step 244 wherein the buyer(s) will have the second biggest discount for that product. At step 242, a determination is made whether the buyer(s) have/has the third highest score, and if NO branches to step 250 which is an end of the process; if the answer is YES then the second system 200 branches to step 246 wherein the buyer(s) will have the third biggest discount for that product.

In FIG. 3, the third system 300 starts at step 310 wherein seller(s) will list X number of products or group of products, and Y is the number of discounts. Here X=100 and Y=3, such that seller(s) offer(s) three different discounts. Then at step 320 the buyers play a game or games, and in step 330 at the end of a deadline, the scores of games of all potential buyers are saved to memory. The system 300 can save the score of each game at the end of that game to the memory (shown in FIG. 4 as memory 450); the step 330 is meant to indicate that all scores are to be saved by the deadline. At step 340, a comparison is made by a computer (e.g., computer 410 shown in FIG. 4) which compares scores to determine the N highest scorers.

At step 350, the system 300 provides discounts to each of the N highest scorers (here, the top 30 scorers), such that each of the highest scorers will be able to buy one of the listed 100 products with the biggest discount.

At step 360, the system 300 provides discounts to each of the next M buyers (here M=20) with the next best scores, such that each of these next M buyers will be able to buy one of the listed 100 products with the second biggest discount.

At step 370, the system 300 provides discounts to each of the next P buyers (here P=50) with the next best scores, such that each of these next P buyers will be able to buy one of the listed 100 products with the third biggest discount.

FIG. 4 has been described in detail hereinabove. It is noted that the elements of FIG. 4 can be used by the steps of the first system 100, the second system 200, and the third system 300.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A method using a website or an app where merchants and/or sellers will list their products and/or services, comprising the steps of:
providing a game on a website or an app;
enabling at least one buyer or potential buyer to play a game, and if the buyer or potential buyer wins then the price of a product or service will drop by a first predetermined amount in price, while if the buyer loses then the price of the product or service will go up by a second predetermined amount in price.

2. A method using a website or an app where merchants and/or sellers will list a number of products and/or services, comprising the steps of:
providing a game on a website or an app;
enabling at least one buyer or potential buyer to play within a time frame such that whoever among the buyers or potential buyers has the best score and/or best time will have the best discounted price.

3. A method using a website or an app where merchants and/or sellers will list their products and/or services and buyers or potential buyers can compete for discounts, comprising the steps of:
providing a first system enabling at least one seller or merchant to list products and/or services, and providing a game for at least one buyer or potential buyer to play;
said first system providing a price drop when the buyer or potential buyer wins, and providing a price increase when the buyer or potential buyer does not win;
said first system allowing the buyer or potential buyer to play the game again following a win, and also allowing the buyer or potential buyer to play the game again when the buyer or potential buyer does not win;
and at the end of play the buyer or potential buyer purchases a product or service at a discount according to the results of play.

4. A method using a website or an app where merchants and/or sellers will list their products and/or services and buyers or potential buyers can compete for discounts, comprising the steps of:
providing a computer and a computer memory;
providing a system for listing X number of products and/or services and providing Y number of discounts, and providing a game for a plurality of buyers or potential buyers to play; and the system providing for N scorers to win a highest discount level, M scorers to win a second highest discount level;
said system storing scores to said computer memory and using said computer to determine the N highest scorers and provide said highest discount level to said N highest scorers; and
using said computer to determine the next M highest scorers and provide said second discount level to said next M highest scorers.
